(19) United States
(12) Patent Application Publication
(10) Pub. No.: US 2025/0083429 A1
(43) Pub. Date: Mar. 13, 2025

(54) POLYESTER MULTILAYER PLASTICS AND RELATED METHODS

(71) Applicant: BOARD OF TRUSTEES OF MICHIGAN STATE UNIVERSITY, East Lansing, MI (US)

(72) Inventor: Muhammad Rabnawaz, Okemos, MI (US)

(21) Appl. No.: 18/580,263

(22) PCT Filed: Jul. 22, 2022
(86) PCT No.: PCT/US2022/037975

§ 371 Date: Jan. 18, 2024

Related U.S. Application Data
(60) Provisional application No. 63/224,710, filed on Jul. 22, 2021.

(51) Int. Cl. B32B 27/36; B32B 7/02; B32B 27/08; B32B 27/16; B32B 27/20

(52) U.S. Cl. CPC B32B 27/36; B32B 7/02; B32B 27/08; B32B 27/16; B32B 27/20; B32B 2250/03; B32B 2250/244; B32B 2307/31; B32B 2307/54; B32B 2307/7163; B32B 2307/7244; B32B 2307/7246; B32B 2307/7376; B32B 2307/748; B32B 2307/75; B32B 2439/40

(57) ABSTRACT

The disclosure relates to polyester-based multilayer plastic (MLP) articles having improved heat sealability, improved gas barrier properties, and/or improved mechanical properties. The MLP article includes first, second, and third polyester layers in a laminate or composite structure. The first polyester layer is a heat-scalable layer, the second polyester layer is a gas-barrier layer, and the third polyester layer is a functional layer providing improved mechanical or printability properties. The MLP article provides desired structural and functional properties for a wide variety of packaging applications, and the use of polyester components for each layer in the MLP article facilitates multiple effective end-of-life recycling options, including mechanical and chemical recycling routes.

### CROSS REFERENCE TO RELATED APPLICATION

Priority is claimed to U.S. Provisional Application No. 63/224,710 (filed Jul. 22, 2021), which is incorporated herein by reference in its entirety.

### STATEMENT OF GOVERNMENT INTEREST

None.

### BACKGROUND OF THE DISCLOSURE

### Field of the Disclosure

The disclosure relates to polyester-based multilayer plastic (MLP) articles having improved heat sealability, improved gas barrier properties, and/or improved mechanical properties. The MLP article includes first, second, and third polyester layers in a laminate or composite structure. The MLP article provides desired structural and functional properties for a wide variety of packaging applications, and the use of polyester components for each layer in the MLP article facilitates multiple effective end-of-life recycling options.

### Brief Description of Related Technology

Due to their adaptability and affordability, over 100 million tons/year of flexible and rigid multilayer plastics (MLPs) are produced worldwide, accounting for >30% of all plastics produced. However, MLPs possess complex structures comprised of up to 12 layers of various materials with different physical, mechanical, and chemical properties. This complexity limits the recyclability of MLPs and obstructs the development of end-of-life (EoL) solutions.

For example, various components such as metalized films, nylons, poly(ethylene terephthalate) (PET), tie layers (adhesive layers), each possess different chemical reactivity, poor miscibility, and varying melt-processability, which in turn impede efforts to mechanically recycle MLPs. In addition, metalized films are even more challenging to melt-reprocess as metal melts at very high temperatures at which the plastic components decompose entirely. Similarly, chemical recycling of MLPs (e.g., pyrolysis, catalytic cracking, gasification, and depolymerization) is challenging due to the generation of harmful byproducts, such as nitriles and hydrogen cyanide from nylon bearing MLPs, while catalyst poisoning during catalytic cracking presents another issue. Furthermore, 10-15% of MLPs never fulfill their designated final packaging application due to the need for templated trimming, and they are thus a leading contributor to post-industrial waste due to their poor recyclability.

One approach to the problem of poor recyclability is the utilization of several polyethylenes of varying degrees of branching to preserve the improved multilayer properties while generating a material that is directly recyclable. One commercial product (“RECYCLE READY”) is a multilayer product comprised of all-polyethylene layers along with polyethylene vinyl alcohol (EVOH) as a middle barrier layer, but it is difficult to chemically recycle, and its mechanical properties are weaker than those of nylon-based MLPs. Through the newly emerging vitrimer chemistry, one can improve the mechanical properties of “all-polyethylene MLPs”, but achieving control over the rheology and the crosslinking degree of vitrimer is highly challenging. Aside from their weaker performance, all-polyethylene MLPs are still challenging to recycle. For example, it is difficult to recycle all-polyethylene MLPs at their end-of-life (EOL) due to the poor compatibility of mixed polyethylenes when melt-blended. To mitigate this issue, costly compatibilizers can be added, but with limited success due to the economics. Also, the separation of individual layers from MLP structures is costly. The only EOL outcome for the all-polyethylene MLPs is their pyrolysis/cracking/gasification into fuels of very little value rather than recovering their corresponding high-value monomers. Considering the current performance and EOL options, the replacement of high-performing MLPs with all-polyethylene MLPs is currently less feasible.

### SUMMARY

The disclosure relates to polyester-based multilayer plastic (MLP) articles having improved heat sealability, improved gas barrier properties, and/or improved mechanical properties. The MLP article includes first, second, and third polyester layers in a laminate or composite structure. The first polyester layer is a heat-sealable layer, the second polyester layer is a gas-barrier layer, and the third polyester layer is a functional layer providing improved mechanical or printability properties. The MLP article provides desired structural and functional properties for a wide variety of packaging applications, and the use of polyester components for each layer in the MLP article facilitates multiple effective end-of-life recycling options, including mechanical and chemical recycling routes.

In one aspect, the disclosure relates to a multilayer plastic (MLP) article comprising: (a) a first polyester layer, wherein the first polyester layer is heat-sealable (e.g., a bottom or product-facing layer in the MLP article); (b) a second polyester layer adjacent to (e.g., bound to or otherwise in contact with) the first polyester layer, wherein the second polyester layer is a gas-barrier layer (e.g., a middle layer in the MLP article that limits, substantially reduces, or prevents transmission of one or more gas species such as oxygen gas, water vapor, etc.); and (c) a third polyester layer adjacent to (e.g., bound to or otherwise in contact with) the second polyester layer at an opposite surface of the second polyester layer relative to the first polyester layer, wherein the third polyester layer is a mechanical and/or printability layer (e.g., a top or environment-facing layer in the MLP article that provides mechanical strength to the article and/or that provides a surface suitable for printing such as for a package label).

In another aspect, the disclosure relates to a packaged product comprising: (a) a packaged article (e.g., food item or otherwise); and (b) the MLP article according to any of the variously disclosed refinements, embodiments, etc. at least partially enclosing the packaged article.

In another aspect, the disclosure relates to a method for recycling an MLP article (e.g., post-consumer or post-industrial), the method comprising: (a) mechanically recycling (e.g., melt-processing) the MLP article according to any of the variously disclosed refinements, embodiments, etc., thereby forming a homogeneous polyester blend (e.g., containing up to about 5 wt. % of non-polyester polymer impurities from original waste stream with the MLP articles, such as LDPE, LLDPE, other polyethylenes or polyolefins, etc.) of the polyesters from each polyester layer; and (b) optionally re-forming the homogeneous polyester blend into an article selected from the group consisting of bottles, containers, sheets, and fibers.

In another aspect, the disclosure relates to a method for recycling an MLP article (e.g., post-consumer or post-industrial), the method comprising: (a) chemically recycling (e.g., depolymerizing) the MLP article according to any of the variously disclosed refinements, embodiments, etc., thereby forming monomers from each polyester layer; and (b) optionally polymerizing at least one of the formed monomers (e.g., after a separation step) to form a new polymer (e.g., a new polyester or a new polymer such as a polyurethane using a recovered polyol, a polyamine using a recovered polyacid, etc.).

Various refinements of the MLP article, related packaged product, and related methods are possible.

In a refinement, the first polyester layer is selected from the group consisting of polyethylene terephthalate (PET), polyethylene terephthalate glycol-modified (PETG), polytrimethylene terephthalate (PTT), polybutylene terephthalate (PBT), polyethylene isosorbide terephthalate (PEIT), polylactic acid (PLA), polyhydroxy alkanoate (PHA), polybutylene succinate (PBS), polybutylene succinate adipate (PBSA), polybutylene adipate terephthalate (PBAT), polycaprolactone (PCL), poly(ethylene adipate) (PEA), polybutylene succinate terephthalate (PBST), isophthalate-modified copolyesters, and combinations thereof.

In a refinement, the first polyester layer comprises a copolyester selected from the group consisting of isophthalate-modified copolyesters, sebacic acid-modified copolyesters, diethyleneglycol-modified copolyesters, triethyleneglycol modified-copolyesters, cyclohexanedimethanol modified-copolyesters, and combinations thereof.

In a refinement, the first polyester layer comprises a copolyester selected from aliphatic copolyesters, aliphatic-aromatic copolyesters, and combinations thereof.

In a refinement, the second polyester layer is selected from the group consisting of liquid crystalline polyesters, polyethylene furanoate (PEF), polyethylene naphthalate (PEN), poly(glycolic acid) (PGA or polyglycolide), copolymers of PGA and combinations thereof.

In a refinement, the third polyester layer is selected from the group consisting of polyethylene terephthalate (PET), polyethylene terephthalate glycol-modified (PETG), isophthalate-modified copolyesters, sebacic acid-modified copolyesters, diethyleneglycol-modified copolyesters, triethyleneglycol modified-copolyesters, cyclohexanedimethanol modified-copolyesters, and combinations thereof.

In a refinement, the first polyester layer is in direct contact with the second polyester layer; and the second polyester layer is in direct contact with the third polyester layer.

In a refinement, the article is free from non-polyester layers.

In a refinement, the MLP article has a thickness in a range of 40 μm to 1000 μm; the first polyester layer has a thickness in a range of 5 μm to 500 μm; the second polyester layer has a thickness in a range of 2 μm to 200 μm; the third polyester layer has a thickness in a range of 10 μm to 900 μm; and/or a ratio of first:second:third layer thickness is (0.5-2):(0.1-2):(1-4).

In a refinement, the MLP article has a water vapor permeability (WVPR) in a range of 0.1 to 10 g/m² day at 37° C. and 50% RH; and/or the MLP article has an oxygen permeability (OPR) in a range of 0.1 to 10 cc/m² day or 0.1 to 20 cc/m² day at 37° C. and 85% RH.

In a refinement, the MLP article has a tensile strength at break in a range of 10-100 MPa; the MLP article has an elongation at break in a range of 5-500%, and/or the MLP article has a seal strength in a range of 5-100 N/mm.

In a refinement, an outer portion of the third polyester layer comprises a plasma-treated surface for improved printability.

In a refinement, the first polyester layer, the second polyester layer, and the third polyester layer have different compositions.

In a refinement, the first polyester layer and the third polyester layer have at least one polyester component in common; and the second polyester layer has a different composition relative to the first polyester layer and the third polyester layer.

In a refinement, the first polyester layer, the second polyester layer, and the third polyester layer are biodegradable.

In a refinement, the second polyester layer further comprises a solid filler (e.g., one or more of graphene oxide, nanoclay, and/or cellulose nanocrystals to improve barrier performance).

While the disclosed articles, apparatus, methods, and compositions are susceptible of embodiments in various forms, specific embodiments of the disclosure are illustrated (and will hereafter be described) with the understanding that the disclosure is intended to be illustrative, and is not intended to limit the claims to the specific embodiments described and illustrated herein.

### BRIEF DESCRIPTION OF THE DRAWINGS

For a more complete understanding of the disclosure, reference should be made to the following detailed description and accompanying drawings wherein:

FIG. 1 illustrates a multilayer plastic (MLP) article according to the disclosure as well as a corresponding packaged product including the MLP article.

FIG. 2A is a graph illustrating water vapor permeability (WVPR) for an MLP article according to the disclosure.

FIG. 2B is a graph illustrating oxygen permeability (OPR) for an MLP article according to the disclosure.

FIG. 3A is a graph illustrating tensile stress at yield for a mechanically recycled blend corresponding to an MLP article according to the disclosure.

FIG. 3B is a graph illustrating elongation at break for a mechanically recycled blend corresponding to an MLP article according to the disclosure.

FIG. 3C is a graph illustrating impact strength for a mechanically recycled blend corresponding to an MLP article according to the disclosure.

### DETAILED DESCRIPTION

The disclosure is generally directed to multilayer plastic (MLP) articles that include primarily or exclusively polyester layers (e.g., “all-polyester MLPs” as alternatively referenced herein) that can be chemically and/or mechanically recycled while still maintaining their excellent performance for one or more sealing, barrier, mechanical, and/or printing properties. Such all-polyester MLPs provide (completely) recyclable or biodegradable alternative solutions to the existing difficult-to-recycle MLPs, including those of all-polyethylene multilayers. The all-polyester MLPs can provide several benefits, including manufacturing simplicity, high performance, and improved recyclability.

Manufacturing Simplicity: The fabrication of all-polyester MLPs does not require tie layers because of the strong interactions (non-covalent and covalent) that exist between co-extruded polyester layers, which is not the case with polyethylene that bears EVOH in MLPs or other MLPs with different classes of materials. In addition, polyesters are available at prices comparable to that of high-density polyethylene (HDPE), and all-polyester MLPs can be cost-economical alternatively to all-polyethylene MLPs.

Performance: All-polyester MLPs can provide very high gas barrier properties (e.g., comparable to that of metalized films). All-polyester MLPs further can provide excellent mechanical properties (e.g., tensile, puncture resistance, and/or stress crack resistance) matching those of nylons based nonrecyclable MLPs, etc.

Improved recyclability: All-polyester MLPs are highly recyclable through a variety of different alternative processes, which stands in stark contrast with polyethylene-based or other existing mixed plastics. For example, the layers of all-polyester MLPs are compatible with each other because of the strong adhesion and good miscibility between similar materials; thus, compatibilizers are generally not required. Therefore, all-polyester MLPs can be mechanically recycled (e.g., melt-processed) for applications such as packaging, fibers, automotive, etc., which is not viable with all-polyethylene MLPs or other existing multi-plastics MLPs. In addition, the monomers of all-polyester MLPs can be readily recovered via chemical recycling, which is not feasible with polyethylene or other mixed plastics.

Existing MLPs can include a combination of up to 12 layers, which include various materials such as high-density polyethylene (HDPE), low-density polyethylene (LDPE), polypropylene (PP), linear low-density polyethylene (LLDPE), polyethylene vinyl alcohol (EVOH), polyvinylidene chloride (PVDC), poly(ethylene-co-vinyl acetate) (EVAc), nylons, poly(ethylene terephthalate) (PET), metalized films, inorganic fillers, etc. Each layer has a distinct function. For instance, LLDPE or LDPE fulfill thermal sealing roles; EVOH, PVDC, nylon, and metalized films perform as oxygen barriers; while nylon and PET provide mechanical properties and printability. Nylon also imparts puncture resistance, while PP and HDPE can serve as moisture barriers. The application of numerous tie layers in MLP manufacturing further complicates the structure of MLPs. As an example, five-layered MLPs would typically include three additional tie layers. In addition, the layers are incompatible with each other when melt-blended, thus making their EOL scenario very challenging.

In contrast to existing multi-polymer MLPs or all-polyethylene MLPs, the all-polyester MLPs according to the disclosure can provide the desired different functional features (e.g., one or more of heat-sealability, gas barrier, and other mechanical, physical, or chemical properties) using essentially only polyester layers, while at the same time providing an easily recyclable material processable according to various EOL options as desired (e.g., chemical or mechanical recycling). An illustrative all-polyester MLP article according to the disclosure can include three (e.g., only three, at least three) polyester layers in a laminate-type structure, with each layer serving one or more distinct function(s), for example including a heat-sealable layer, a barrier layer, and a multipurpose layer (e.g., mechanical layer).

Heat-sealable outer layer (first layer; e.g., in contact with or facing towards a product being packaged): For heat sealing, one needs low melting temperature (Tm), flexible materials. There are numerous polyesters that can fulfil this role, such as polybutylene terephthalate, isophthalate-modified copolyesters, aliphatic polyesters, aliphatic copolyesters, aliphatic-aromatic copolymers, etc.

Inner barrier layer (second layer): Multiple options are available to provide an excellent barrier material from polyesters. For example, various liquid crystalline polyesters can provide high gas barrier performance, for example including liquid crystalline aromatic polyesters (e.g., VECTRAN-V200P6 polyarylate fiber available from Kuraray Co., Japan), polyethylene naphthalate, polyglycolide or poly (glycolic acid) (PGA), or polyethylene furanoate. The barrier layers can include additives (e.g., anti-plasticizers, purines, and so forth) to further improve the barrier properties. Orientation can also enhance the barrier properties. Fillers such as clays, graphene (oxides), or cellulose nanocrystals can also be added into the middle layers as barrier enhancers.

Outer multipurpose layer (third layer; e.g., in contact with or facing towards the external environment): For MLPs, the outer layer can provide one or more of moisture resistance, improved/high mechanical properties, ease of printability, and so on. PET is known for its excellent mechanical properties, which can be tailored by adjusting the thickness of the film. PET also offers very good moisture barrier performance. Although PET's moisture barrier performance is lower than that of polyethylene, this does not detract from the overall barrier properties of the all-polyester MLPs, because the middle or inner polyester barrier layers are highly water-resistant, while all-polyethylene MLPs utilize water-sensitive EVOH as an oxygen barrier layer. In addition, PET has better printability than any polyethylene. If desired, the surface printability outer layer can also be further improved by corona/plasma treatment.

In some embodiments, the MLP article can be prepared using a continuous co-extrusion process in which the various polyester layers having desired components (e.g., specific polyester and any additives/fillers), thicknesses, etc. are collectively co-extruded to directly provide a composite laminate structure with distinct layers. In other embodiments, the various polyester layers having desired components, thicknesses, etc. for the different layers can be individually or separately formed (e.g., as films such as formed by casting, extrusion, etc.), and then the individual layers can be laminated together in a subsequent step.

The all-polyester MLPs according to the disclosure are designed to be highly and easily recyclable, which is not the case for existing MLPs. The all-polyester MLPs according to the disclosure provide multiple different EOL solution options, such as mechanical recycling as well as chemical recycling.

Mechanical Recycling: A common problem with conventional MLPs is the phase separation of each plastic layer when these materials are melt-blended, for example in a mechanical recycling process. Phase separations weaken the performance of polymer blends, thus causing the loss of essentially all of their value. Compatibilization can enhance the performance of immiscible blends, but it can be a costly process. In contrast to these problems for conventional MLPs, the disclosed all-polyester MLPs provide easily recyclable substitutes or alternatives to the conventional MLPs because of the greater miscibility of all-polyester MLPs without requiring any compatibilizers (i.e., since all layers are polyesters). This is a major advantage for the EOL options of MLPs and thus paves the pathway for the recycling of post-industrial and post-consumer MLPs to enable their re-entry into packaging and non-packaging manufacturing streams. For example, in an illustrative mechanical recycling process, an all-polyester MLP with at least three different polyester layers can be melt-blended in a single or twin-screw extruder (or other melt-processing apparatus) to provide a recycled polyester blend that can be used for various applications such as bottles, containers, sheets, fibers, etc. In some embodiments, the additional processing steps can include chain extension and/or solid-stating polymerization to enhance the physico-mechanical properties of the resulting all-polyester MLP blends. The melt flow indices (MFIs) of the resulting all-polyester MLP blend can be adjusted for desirable applications such as bottles, containers, sheets, fibers, and so on. Such all-polyester MLP blends can provide a matching or exceeding performance compared to their respective commercial benchmarks for the targeted application.

Chemical Recycling: The all-polyester MLPs according to the disclosure can also be chemically recycled because of their polyester nature. While PET is widely explored for chemical recycling, many technologies are also available for the chemical recycling of this polymer. A suitable method for chemical recycling of polyesters is disclosed in International Application No. PCT/US22/23444, incorporated herein by reference. Regardless of the specific technique, the all-polyester MLPs can be depolymerized into monomers or other small molecules for various applications. For example, using diols or triols for the depolymerization of all-polyester MLPs, the resulting products can be used as feedstocks for polyurethanes as well as alkyd coating applications. Similarly, monomers recovered via chemical recycling can be used as feedstock chemicals for the synthesis of new polyesters.

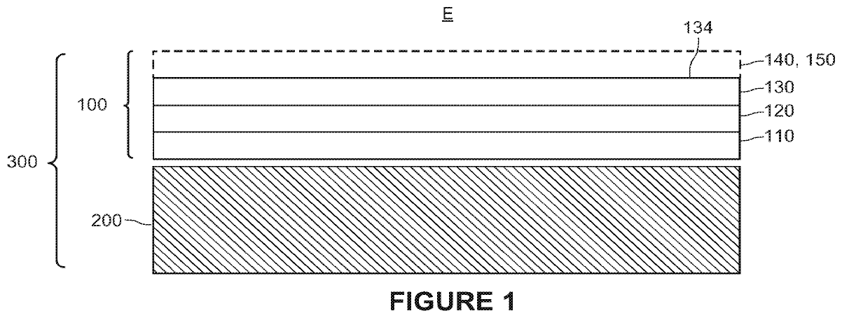

FIG. 1 illustrates a multilayer plastic (MLP) article (or all-polyester MLP) 100 according to the disclosure as well as a corresponding packaged product 300 including the MLP article 100. As illustrated, the MLP article 100 includes a first polyester layer 110, a second polyester layer 120, and a third polyester layer 130. The first polyester layer 110 is a heat-sealable layer, for example forming a bottom or product-facing layer in the MLP article 100 once incorporated into the packaged product 300. The second polyester layer 120 is adjacent to the first polyester layer 110, for example being bound/adhered to or otherwise in (direct) contact with the first polyester layer 110. The second polyester layer 120 is a gas-barrier layer, for example being a middle or interior layer in the MLP article 100 that limits, substantially reduces, or prevents transmission of one or more gas species such as oxygen gas, water vapor, etc. The third polyester layer 130 is adjacent to the second polyester layer 120 at an opposite surface of the second polyester layer 120 relative to the first polyester layer 110, for example being bound/adhered to or otherwise in (direct) contact with the second polyester layer 120. The third polyester layer 130 can be selected to provide desired properties, for example providing desired mechanical properties (e.g., a mechanical layer imparting desired mechanical strength to the MLP article 100) and/or printability properties (e.g., a printability layer amenable to printing such as to provide a packing label or other text/symbols). The third polyester layer 130 can be a top or environment-facing layer in the MLP article 100, for example being in contact with the external environment E (e.g., ambient atmosphere) or other additional (optional) polyester layer(s) providing additional functions or properties to the MLP article 100.

In embodiments, the various adjacent polyester layers in the MLP article 100 can be in direct contact with each other, for example without an intervening tie layer, adhesion layer, or other (non-polyester) layer. For example, as illustrated in FIG. 1, the first polyester layer 110 can be in direct contact with the second polyester layer 120, being directly bound or otherwise adhered thereto, without an intervening tie or adhesion layer Similarly, the second polyester layer 120 can be in direct contact with the third polyester 130 layer, being directly bound or otherwise adhered thereto, without an intervening tie or adhesion layer.

In embodiments, the MLP article 100 is suitably free from non-polyester layers to promote recyclability of the MLP article 100. While the MLP article 100 can include one or more (solid) fillers or additives such as clays, etc. to improve gas barrier or other properties, the MLP article 100 suitably does not include any polymeric layers or components other than polyester layers or components. Accordingly, the MLP article 100 can include optional fourth 140, fifth 150, etc. additional layers to tailor the final properties of the MLP article 100, but such optional additional layers are polyester layers when present. The optional additional polyester layers 140, 150 are illustrated with the dashed line in FIG. 1 as being adjacent to the third polyester layer 130, but they can have any desired position relative to the first, second, and third layers 110, 120, 130 depending on the function on the additional layers (e.g., adjacent to in between any of the layers 110, 120, 130).

The MLP article 100 can have any desired overall thickness for a given application. In common applications, the MLP article 100 suitably has an overall thickness in a range of 40 μm to 1000 μm, which includes the combined or total thickness of the first, second, and third layers 110, 120, 130 as well as any optional layers. For example, the overall thickness of the MLP article 100 can be at least 40, 60, 80, 100, 150, 200, 250, 300, 350, 400, 500, 600, or 700 μm and/or up to 50, 70, 90, 120, 180, 240, 300, 350, 400, 500, 600, 700, 800, 900, or 1000 μm. In embodiments, the first polyester layer can have a thickness in a range 5 μm to 500 μm, for example a thickness of at least 5, 10, 15, 20, 30, 50, 70, 100, or 150 μm and/or up to 20, 30, 40, 60, 80, 100, 150, 200, 350, or 500 μm. In embodiments, the second polyester layer can have a thickness in a range 2 μm to 200 μm, for example a thickness of at least 2, 4, 8, 15, 20, 30, or 40 μm and/or up to 8, 12, 20, 30, 40, 60, 80, 100, 150, or 200 μm. In embodiments, the third polyester layer can have a thickness in a range 10 μm to 900 μm, for example a thickness of at least 10, 20, 40, 80, 150, 200, 300, or 400 μm and/or up to 30, 60, 90, 120, 180, 240, 300, 400, 500, 600, 700, 800, or 900 μm. When present, any additional layers (e.g., fourth or fifth polyester layers 140, 150) can have a thickness selected from any of the foregoing ranges for the first, second, and third layers 110, 120, 130.

The MLP article 100 additionally can be characterized by the relative thickness of its layers. In embodiments, a ratio of third:second:first layer thickness can be (1-4):(0.1-2):(0.5-2), (1.5-3):(0.2-1):(0.7-1.5), or (1.7-2.5):(0.4-0.9):(0.9-1.2). Alternatively or additionally, a ratio of first: second layer thickness can be 20:1, 15:1, 10:1, 6:1, 4:1, 2:1, 1.5:1, 1:1, 1:1.2, 1:1.5, 1:2, 1:3, 1:4, or any sub-range between any of the foregoing ratios. Alternatively or additionally, a ratio of first: third layer thickness can be 2:1, 1.5:1, 1.2:1, 1.1:1, 1:1, 1:1.1, 1:1.2,1:1.5, 1:2, 1:3, 1:4, 1:6, 1:8, or any sub-range between any of the foregoing ratios. Alternatively or additionally, a ratio of second: third layer thickness can be 2:1, 1.5:1, 1.2:1, 1.1:1, 1:1, 1:1.1, 1:1.2. 1:1.5, 1:2, 1:3, 1:4, 1:6, 1:8, 1:15, 1:20, 1:30, 1:40, or any sub-range between any of the foregoing ratios.

The favorable gas barrier properties of the MLP article 100 can be characterized by one or both of its resistance to water vapor transmission and its resistance to oxygen transmission, which can alternatively be expressed as water vapor permeability and oxygen permeability, respectively. In embodiments, the MLP article 100 can have a water vapor transmittance (WVTR) or water vapor permeability (WVPR) in a range of 0.1 to 10 g/m² day, for example determined at 23° C. or 37° C. and 50% or 85% relative humidity (RH). For example, the WVTR or WVPR value can be at least 0.1, 0.2, 0.4, 0.6, 0.8, 1, 1.5, 2, 3, 4, or 5 g/m² day and/or up to 0.5, 0.7, 1, 1.5, 2, 3, 4, 5, 6, 7, 8, 9, or 10 g/m² day. In embodiments, the MLP article 100 can have an oxygen transmittance (OTR) or oxygen permeability (OPR) in a range of 0.1 to 10 cc/m² day or 0.1 to 20 cc/m² day, for example determined at 23° C. or 37° C. and 50% or 85% relative humidity (RH). For example, the OTR or OPR value can be at least 0.1, 0.2. 0.4, 0.6, 0.8, 1, 1.5, 2, 3, 4, or 5 cc/m² day and/or up to 0.5, 0.7, 1, 1.5, 2, 3, 4, 5, 6, 7, 8, 9, 10, 12, 15, or 20 cc/m² day.

The favorable mechanical properties of the MLP article 100 can be characterized by one or more of its tensile strength at break, elongation at break, and seal strength, for example as determined by a suitable tensile testing apparatus. In embodiments, the MLP article 100 can have a tensile strength at break in a range of 10-100 MPa, for example at least 10, 20, 30, 40, or 50 MPa and/or up to 25, 35, 50, 65, 80, or 100 MPa. In embodiments, the MLP article 100 can have an elongation at break in a range of 5-500%, for example at least 5, 10, 20, 40, 80, 120, 150, or 200% and/or up to 25, 50, 75, 100, 160, 240, 320, 400, or 500%. In embodiments, the MLP article 100 can have a seal strength in a range of 5-100 N/mm, for example at least 5, 10, 15, 25, 35, or 50 N/mm and/or up to 25, 35, 50, 65, 80, or 100 N/mm.

In embodiments, an outer (e.g., environment-facing) portion or surface 134 of the third polyester layer 130 can include a plasma-treated surface for improved printability. Such plasma treating processes are known in the art and can impart additional hydrophilic or hydrophobic surface groups onto the third polyester layer 130 for compatibility with a printing ink, for example hydrophilic surface hydroxyl and/or carbonyl groups resulting from plasma treatment in air or an oxygen-containing atmosphere. In cases where the MLP article 100 includes other additional polyester layers (e.g., fourth or fifth layers 140, 150 as described above), the plasma-treated surface can be incorporated onto any desired polyester layer, for example whatever polyester layer is the outer or environment-facing layer in the final MLP article 100.

In embodiments, an additional layer can be interposed between the third polyester layer 130 and the second polyester layer 120 to further enhance barrier properties. This additional layer can be or otherwise include alumina, silica, or other organic or inorganic material sealed/bound directly onto the second polyester layer 120.

In various embodiments, the various polyester layers can be formed form or otherwise include the same or different polyester components, although the second polyester layer 120 is generally different from (or contains a different polyester component relative to) the first and third polyester layer 110, 130 in order to provide the desired gas barrier properties. One polyester component can be different from another polyester component based on one or more of different monomer unit(s), different molecular weights, etc. Similarly, polyester layers having the same polyester components can still be different when they contain different relative amounts of the polyester components. For example, in some embodiments, the first polyester layer 110, the second polyester layer 120, and the third polyester layer 130 can have different compositions, such as all containing different polyester components. In other embodiments, the first polyester layer 110 and the third polyester layer 130 can have at least one polyester component in common, for example having the same polyester components and/or relative amounts. Similarly, the second polyester layer 120 can have a different composition relative to the first polyester layer 110 and the third polyester layer 130, for example where the second layer 120 contains different polyester component(s) and/or relative component amounts compared to the first and third layers 110, 130.

As further illustrated in FIG. 1, the packaged product 300 according to the disclosure includes a packaged article 200 and the MLP article 100 at least partially enclosing (e.g., completely enclosing) the packaged article 200. The packaged article 200 in not particularly limited and can include food items or any other article that is desired to be protected or isolated from potential contaminants in the external environment, for example including oxygen/air, water (vapor or liquid), other liquids, touching by a person, etc.

A wide variety of polyesters can be used for the different layers in the MLP article 100 based on the desired properties of the overall article. Specific selections that are particularly suitable for the first, second, and third polyester layers 110, 120, and 130 are described in more detail below. More generally, however, the polyester for any particular layer can be a thermoplastic polyester reaction product between an alkylene diol and a dicarboxylic acid or an ester thereof. Suitable dicarboxylic acids can include aromatic, aliphatic, or cycloaliphatic dicarboxylic acids. Example aromatic dicarboxylic acids include 2,6-naphthalenedicarboxylic acid, terephthalic acid, and isophthalic acid, and mixtures of these. The aromatic ring can be substituted, for example with a halogen, such as chlorine or bromine, or C1-C4 alkyl, such as methyl, ethyl, isopropyl, n-propyl, n-butyl, isobutyl, or tert-butyl group. The dicarboxylic acid can also have a heteroatom-substituted ring (e.g., an aromatic ring including one or more N, O, or S heteroatoms), for example as furan-2,5-dicarboxylic acid. Example aliphatic or cycloaliphatic dicarboxylic acids include adipic acid, succinic acid, azelaic acid, sebacic acid, dodecanedioic acids, and cyclohexanedicarboxylic acids. Suitable alkylene diols can include aliphatic or cycloaliphatic dihydroxy compounds, for example diols having from 2 to 6 carbon atoms, in particular 1, 2-ethanediol, 1,3-propanediol, 1,4-butanediol, 1,6-hexanediol, 1,4-hexanediol, 1,4-cyclohexanediol, 1,4-cyclohexanedimethylanol, and neopentyl glycol, and mixtures of these. For example, the polyester can be a polyalkylene terephthalate preferably having from 2 to 10 carbon atoms in the alkylene diol moiety, for example polyethylene terephthalate (PET). Polyalkylene terephthalates of this type can be prepared by reacting aromatic dicarboxylic acids, or their esters or other ester-forming derivatives, with suitable dihydroxy or diol compounds as described above. Specific examples include polyethylene terephthalate, polytrimethylene terephthalate, polybutylene terephthalate, polyethylene furanoate, polypropylene furanoate, etc.

Similarly, the polyester can be a thermoplastic polyester reaction product of one or more monomers having hydroxy and acid functionality, for example a monomer having a mono-hydroxy and a mono-acid functionality. Examples of such polyesters include polyglycolic acid (PGA or polyglycolide), polylactic acid (PLA or polylactide), polyhydroxyalkanotes (PHA) (e.g., poly(3-hydroxybutyrate), poly(3-hydroxyvalerate), polylactones (e.g., polycaprolactone (PCL), polybutyrolactone, polyvalerolactone), and copolyesters of the foregoing monomer units with or without other diol, diacid, and/or mono-hydroxy/mono-acid monomers.

Further examples of suitable selections for polyesters, whether as single polyesters or blends of two or more different polyesters in the various layers, include polyethylene terephthalate (PET), polyethylene terephthalate glycol-modified (PETG) polytrimethylene terephthalate (PTT), polybutylene terephthalate (PBT), polyethylene isosorbide terephthalate (PEIT), polylactic acid (PLA), polyhydroxy alkanoate (PHA), polybutylene succinate (PBS), polybutylene succinate adipate (PBSA), polybutylene adipate terephthalate (PBAT), polyethylene furanoate (PEF), polycaprolactone (PCL), poly(ethylene adipate) (PEA), polybutylene succinate terephthalate (PBST), polyethylene succinate (PES), poly (butylene succinate/terephthalate/isophthalate)-co-(lactate) (PBSTIL), liquid crystalline polyesters, and combinations thereof. Examples of suitable blends include PET/PETG and PET/PLA. Further examples of suitable selections polyesters include copolyesters such as isophthalate-modified copolyesters, sebacic acid-modified copolyesters, diethyleneglycol-modified copolyesters, triethyleneglycol modified-copolyesters, cyclohexanedimethanol modified-copolyesters, and/or polybutylene terephthalate. Such modified copolyesters generally have at least one of the TPA or EG units in PET at least partially replaced with modifying unit (e.g., at least some terephthalic units replaced with isophthalic units, at least some ethylene glycol units replaced with diethyleneglycol units), for example with 2-50 mol. %, 5-50 mol. %, 10-40 mol. %, 10-20 mol. %, 20-30 mol. %, or 15-30 mol. % replacement by the modifying unit.

In some embodiments, the polyester used for any given layer can be a virgin polyester, a post-consumer polyester, or a blend of virgin and post-consumer polyesters. For example, the polyester used for a given layer can be 100% virgin polyester, 100% post-consumer polyester, or a blend ranging from 5:95 (w/w) to 95:5 (w/w) virgin:post-consumer polyester (e.g., 5:95. 10:90, 20:80, 30:70, 40:60, 50:50, 60:40, 70:30, 80:20, 90:10, 95:5, or a sub-range between any of the foregoing ratios).

In some embodiments, one or more of the first polyester layer, the second polyester layer, and the third polyester layer are biodegradable or contain biodegradable or compostable polyesters, for example where the MLP article 100 is not intended for recycling (e.g., but still provides desired barrier, sealing, and mechanical properties while not contributing to long-term environmental pollution). For example, suitable biodegradable polyesters can include PCL, PHA, PHBV, etc. for the first and third layers, a biodegradable liquid crystalline polyester for the second layer, etc.

The first polyester layer 110 generally is or includes a flexible and/or low-melting polyester to facilitate heat-sealing. For example, suitable melting temperatures can be in a range of 180-280° C. or 200-240° C., such as at least 70, 100, 160, 180, 200, or 220° C. and/or up to 220, 240, 260, 280, or 300° C. Common polyesters having good melting and heat-sealing properties generally include aliphatic polyesters, aliphatic copolyesters, and aliphatic-aromatic copolyesters. Examples of suitable polyesters for the first layer 110 include polyethylene terephthalate (PET), polyethylene terephthalate glycol-modified (PETG), polytrimethylene terephthalate (PTT), polybutylene terephthalate (PBT), polyethylene isosorbide terephthalate (PEIT), polylactic acid (PLA), polyhydroxy alkanoate (PHA), polybutylene succinate (PBS), polybutylene succinate adipate (PBSA), polybutylene adipate terephthalate (PBAT), polycaprolactone (PCL), poly(ethylene adipate) (PEA), polybutylene succinate terephthalate (PBST), isophthalate-modified copolyesters, sebacic acid-modified copolyesters, diethyleneglycol-modified copolyesters, triethyleneglycol modified-copolyesters, and cyclohexanedimethanol modified-copolyesters. Particularly suitable heat-sealing polyesters include PBT, PBAT, and isophthalate-modified copolyesters.

The second polyester layer 120 generally is or includes a polyester having a high resistance to gas transport, in particular oxygen and/or water vapor that can be present in the external environment. In embodiments, the second polyester layer 120 can include or be formed from liquid crystalline polyesters. Such liquid crystalline polyesters can include polymers or copolymers with mesogenic and flexible portions, polymers or copolymers of aromatic phenolic acids, and copolymers of aromatic diphenols and aromatic diacids. Other polyesters having high gas barrier properties can include polyethylene furanoate (PEF), polyethylene naphthalate (PEN), and polyglycolic acid (PGA or polyglycolide), copolymers thereof, and combinations thereof.

In some embodiments, the second polyester layer 120 can include one or more (solid) fillers or additives to improve the gas barrier properties of the second layer 120 and the overall MLP article 100. Fillers or additives useful to improve barrier properties can include clay (nanoclay), graphene, graphene oxide, cellulose nanocrystals, anti-plasticizers, etc. More generally, any of the polyester layers can include any suitable organic or inorganic filler or additive, which can be included to improve one or more of mechanical properties, optical properties, electrical properties, and omniphobic properties of the final composition. Examples of suitable fillers or additives include nanoclay, graphene oxide, graphene, fibers (e.g., carbon fiber, glass fiber, aramid fiber), silsesquioxane, silicon dioxide (silica), aluminum oxide, diatomaceous earth, cellulose nanocrystals, carbon nanotubes, titanium dioxide (titania), and combinations or mixtures thereof. In addition, the fillers can include biocides, pigments, dyes, a thermoplastic material, or a combination thereof. The fillers can be added in the range from 0.01 wt. % to 10 wt. % or 0.01 wt. % to 50 wt. %, for example in range from 1 wt. % to 5 wt. % or 1 wt. % to 20 wt. %, which ranges can be expressed relative to the layer in which they are incorporated or relative to the MLP article as a whole.

The third polyester layer 130 generally is or includes a polyester having good mechanical or physical properties to provide a mechanically strong structure for the corresponding MLP article 100. Examples of suitable polyesters for the third layer 130 include polyethylene terephthalate (PET), polyethylene terephthalate glycol-modified (PETG), isophthalate-modified copolyesters, sebacic acid-modified copolyesters, diethyleneglycol-modified copolyesters, triethyleneglycol modified-copolyesters, and cyclohexanedimethanol modified-copolyesters.

The MLP article 100 according to the disclosure can be recycled via thermal processing, for example melt-processing such as extruding. In some embodiments, the melt-processing corresponds to a mechanical recycling step in which the MLP article 100 to be recycled is heated to a temperature above the melting temperature of its polyester components and below their decomposition temperatures, for example in an extruder, so that the resulting polyester blend can be formed into any desired shape (e.g., pellets or granules for any desired subsequent use). Common melt-processing temperatures can range from about 80° C. to 280° C. (e.g., at least 80, 150, or 200° C. and/or up to 150, 200, 250, or 280° C.), which is typically suitable for common polyesters such as PET and PLA. Higher or lower temperatures may be suitable for other polymers with varying melting points. For example, melt-processing can be performed at a temperature that is at least 10 or 20° C. and/or up to 50 or 100° C. above the melting point of the polyesters. In an alternative embodiment, thermal processing can include heating to perform solid state polycondensation or polymerization (SSP), either with or without melt-processing the recycled polyester composition. For example, the MLP article 100 could be first melt-processed, and then subjected to SSP, or the MLP article 100 could be subjected to SSP without melt-processing.

In a particular embodiment, the MLP article 100 can be mechanically recycled (e.g., melt-processed) to form a homogeneous polyester blend of the polyesters from each polyester layer in the original MLP article 100. The resulting blend can include up to about 1, 2, or 5 wt. % of non-polyester polymer impurities from an original waste stream with the MLP articles, such as LDPE, LLDPE, other polyethylenes or polyolefins, etc. Such minor amounts of non-polyester polymers in the resulting polyester blend do not adversely affect the miscibility or compatibility of the components in the blend to a degree that would substantially degrade the physical or chemical properties of the blend. The homogeneous polyester blend can be used to re-form recycled polyester products such as bottles, containers, sheets, fibers, etc. using any suitable process such as extrusion, injection molding, casting, etc.

In another particular embodiment, the MLP article 100 can be chemically recycled or depolymerized to form monomers from or otherwise corresponding to the polyesters in the various layers. One or more of the resulting monomers can be polymerized to form a new polymer, for example after a separation step to obtain isolated single monomers. For example, newly formed polymers can include a new polyester, or a new, non-polyester polymer such as a polyurethane using a recovered polyol, a polyamine using a recovered polyacid, etc.

### Examples

The following examples illustrate the disclosed articles, compositions, and methods, but are not intended to limit the scope of any claims thereto.

### Example 1

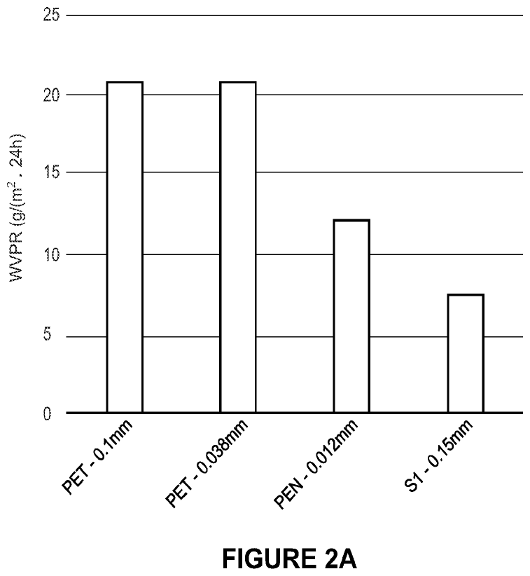

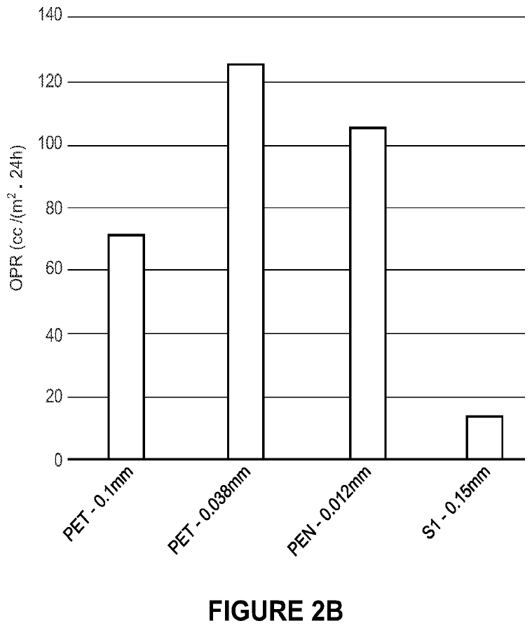

An MLP article according to the disclosure was formed from a PET first layer (0.038 mm thick), a PEN second layer (0.012 mm thick), and a PET third layer (0.1 mm thick), which were purchased commercial polyester films with the desired thickness. The all-polyester MLP according to the disclosure was formed by combining the different polyester films. A composite film S1 corresponding to an MLP article according to the disclosure was prepared by compression molding PET 0.1 mm (third layer) and PET 0.038 mm (as the first layer), with polyethylene naphthalate (PEN) as an interposed middle (second) barrier layer at 210° C. for 30 seconds. The composite film S1 was then tested for its barrier gas and vapor barrier properties. For comparison, the neat PET (0.1 mm), PET (0.038 mm), and PEN films were also characterized for their barrier properties as control samples. Oxygen and water vapor barrier properties were tested by employing MOCON OX-TRAN 2/22 (L) and MOCON PERMATRAN-W 3/34 instruments, respectively. The oxygen permeation rate was tested at a temperature of 37° C. and relative humidity (RH) of 85%, while the water vapor permeation rate was tested at 37° C. and 50% RH. The results are shown in FIG. 2A (water vapor permeability) and in FIG. 2B (oxygen permeability).

### Example 2

An MLP article according to the disclosure was formed using a liquid crystalline polyester (“LCP”; VECTRAN A950 available from Kuraray) as the second barrier layer. As in Example 1, the film for the second layer was laminated with polyester first and third layer films to form the composite structure corresponding to the MLP article. Oxygen and water vapor barrier properties were tested by employing MOCON OX-TRAN 2/22 (L) and MOCON PERMATRAN-W 3/34 instruments, respectively. WVTR and OTR were determined at 23° C. and 50% RH. The results are shown in Table 1.

TABLE 1
Gas Barrier Properties for MLP Articles
with Liquid Crystalline Polyester Layers

| Sample | Composition | WVTR (g/(m²day)) | OTR (cc/(m²day)) |
|---|---|---|---|
| C1 | terephthalate-based | 13.3 | 39.4 |
| | copolyester | | |
| C2 | PET | 49.9 | 144 |
| C3 | PBAT | 527 | 1960 |
| S2 | C2/LCP/C3 | Not detected | 10.6 |
| S3 | C2/LCP/C1 | Not detected | 11.6 |

### Example 3

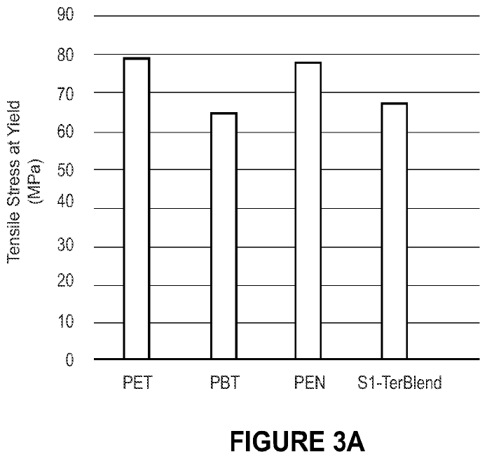

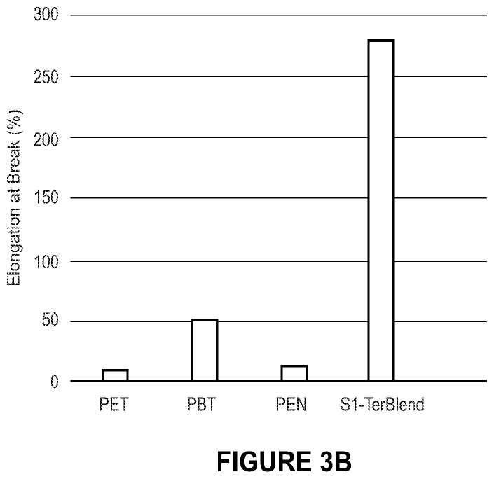

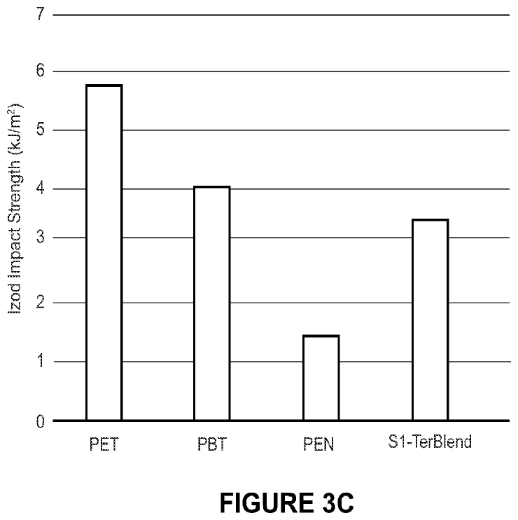

Mechanical recycling of an MLP article was modeled by blending a mixture of PET/PEN/PBT at a 60:20:20 (w/w) ratio to represent a 3:1:1 third:second:first layer thickness ratio of a corresponding MLP article. The blend was extruded at 280° C. for 5 min and denoted as S1-TerBlend. The mechanical properties of the resulting blend were evaluated to determine whether an MLP article with thicknesses selected for suitable barrier, sealing, etc. properties in a packaging setting would form a polyester blend with suitable mechanical properties for use as a recycled polyester to form other recycled products. Interestingly, the ternary blend showed not only good tensile stress at yield (FIG. 3A), but also showed excellent elongation (FIG. 3B) and impact strength (FIG. 3C). The clarity of S1-TerBlend corresponds to transesterification among the three polyesters, which has reduced the crystallinity and with enhanced compatibility among the blended polyesters.

### Example 4

Chemical recycling of an MLP article was modeled by blending a mixture of PET/PEN/PBT at a 60:20:20 (w/w) ratio to represent a 3:1:1 third:second:first layer thickness ratio of a corresponding MLP article. The mixtures were blended either (i) in the absence of any catalyst, or (ii) in the presence of a zinc acetate catalyst. Both samples were subjected to glycolysis at 180° C. for 4 hours. Weight loss analysis confirmed 97% depolymerization in for the sample including the zinc acetate catalyst, while only about 20% depolymerization occurred in the sample without catalyst. The example demonstrates that extrusion an MLP article with an internal catalyst can provide rapid depolymerizing of ternary polyester blends in chemical recycling application.

Accordingly, the foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In case of conflict, the present description, including definitions, will control.

Throughout the specification, where the compositions, processes, or apparatus are described as including components, steps, or materials, it is contemplated that the compositions, processes, or apparatus can also comprise, consist essentially of, or consist of, any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

What is claimed is:

1. A multilayer plastic (MLP) article comprising:
(a) a first polyester layer, wherein the first polyester layer is heat-sealable;
(b) a second polyester layer adjacent to the first polyester layer, wherein the second polyester layer is a gas-barrier layer; and
(c) a third polyester layer adjacent to the second polyester layer at an opposite surface of the second polyester layer relative to the first polyester layer, wherein the third polyester layer is a mechanical and/or printability layer.

2. The article of claim 1, wherein the first polyester layer is selected from the group consisting of polyethylene terephthalate (PET), polyethylene terephthalate glycol-modified (PETG), polytrimethylene terephthalate (PTT), polybutylene terephthalate (PBT), polyethylene isosorbide terephthalate (PEIT), polylactic acid (PLA), polyhydroxy alkanoate (PHA), polybutylene succinate (PBS), polybutylene succinate adipate (PBSA), polybutylene adipate terephthalate (PBAT), polycaprolactone (PCL), poly(ethylene adipate) (PEA), polybutylene succinate terephthalate (PBST), isophthalate-modified copolyesters, and combinations thereof.

3. The article of claim 1, wherein the first polyester layer comprises a copolyester selected from the group consisting of isophthalate-modified copolyesters, sebacic acid-modified copolyesters, diethyleneglycol-modified copolyesters, triethyleneglycol modified-copolyesters, cyclohexanedimethanol modified-copolyesters, and combinations thereof.

4. The article of claim 1, wherein the first polyester layer comprises a copolyester selected from aliphatic copolyesters, aliphatic-aromatic copolyesters, and combinations thereof.

5. The article of claim 1, wherein the second polyester layer is selected from the group consisting of liquid crystalline polyesters, polyethylene furanoate (PEF), polyethylene naphthalate (PEN), poly(glycolic acid) (PGA), and combinations thereof.

6. The article of claim 1, wherein the third polyester layer is selected from the group consisting of polyethylene terephthalate (PET), polyethylene terephthalate glycol-modified (PETG), isophthalate-modified copolyesters, sebacic acid-modified copolyesters, diethyleneglycol-modified copolyesters, triethyleneglycol modified-copolyesters, cyclohexanedimethanol modified-copolyesters, and combinations thereof.

7. The article of claim 1, wherein:
the first polyester layer is in direct contact with the second polyester layer; and
the second polyester layer is in direct contact with the third polyester layer.

8. The article of claim 1, wherein the article is free from non-polyester layers.

9. The article of claim 1, wherein:
the MLP article has a thickness in a range of 40 μm to 1000 μm;
the first polyester layer has a thickness in a range of 5 μm to 500 μm;
the second polyester layer has a thickness in a range of 2 μm to 200 μm;
the third polyester layer has a thickness in a range of 10 μm to 900 μm; and
a ratio of first:second:third layer thickness is (0.5-2):(0.1-2):(1-4).

10. The article of claim 1, wherein:
the MLP article has a water vapor permeability (WVPR) in a range of 0.1 to 10 g/m² day at 37° C. and 50% RH; and
the MLP article has an oxygen permeability (OPR) in a range of 0.1 to 10 cc/m² day at 37° C. and 85% RH.

11. The article of claim 1, wherein:
the MLP article has a tensile strength at break in a range of 10-100 MPa;
the MLP article has an elongation at break in a range of 5-500%, and
the MLP article has a seal strength in a range of 5-100 N/mm.

12. The article of claim 1, wherein an outer portion of the third polyester layer comprises a plasma-treated surface for improved printability.

13. The article of claim 1, wherein the first polyester layer, the second polyester layer, and the third polyester layer have different compositions.

14. The article of claim 1, wherein:
the first polyester layer and the third polyester layer have at least one polyester component in common; and
the second polyester layer has a different composition relative to the first polyester layer and the third polyester layer.

15. The article of claim 1, wherein the first polyester layer, the second polyester layer, and the third polyester layer are biodegradable.

16. The article of claim 1, wherein the second polyester layer further comprises a solid filler.

17. A packaged product comprising:
(a) a packaged article; and
(b) the MLP article of claim 1 at least partially enclosing the packaged article.

18. A method for recycling an MLP article, the method comprising:
(a) mechanically recycling the MLP article of claim 1, thereby forming a homogeneous polyester blend of the polyesters from each polyester layer; and
(b) optionally re-forming the homogeneous polyester blend into an article selected from the group consisting of bottles, containers, sheets, and fibers.

19. A method for recycling an MLP article, the method comprising:
(a) chemically recycling the MLP article of claim 1, thereby forming monomers from each polyester layer; and
(b) optionally polymerizing at least one of the formed monomers to form a new polymer.
